(19) United States
(12) Patent Application Publication
(10) Pub. No.: US 2013/0342859 A1
(43) Pub. Date: Dec. 26, 2013

(54) IMAGE FORMING APPARATUS, IMAGE DATA CONVERTER TO CONVERT IMAGE DATA THEREFOR, AND METHOD OF CONVERTING IMAGE DATA THEREFOR

(71) Applicants: Tadashi KASAI, Kanagawa (JP); Yuichi Aizawa, Kanagawa (JP); Makoto Yasuda, Kanagawa (JP); Masato Iio, Kanagawa (JP); Yoichi Sakurai, Kanagawa (JP); Masakazu Terao, Kanagawa (JP)

(72) Inventors: Tadashi KASAI, Kanagawa (JP); Yuichi Aizawa, Kanagawa (JP); Makoto Yasuda, Kanagawa (JP); Masato Iio, Kanagawa (JP); Yoichi Sakurai, Kanagawa (JP); Masakazu Terao, Kanagawa (JP)

(21) Appl. No.: 13/903,369

(22) Filed: May 28, 2013

(30) Foreign Application Priority Data
Jun. 26, 2012 (JP) 2012-143026

(51) Int. Cl. G06K 15/02

(52) U.S. Cl. CPC G06K 15/1801
USPC 358/1.9

(57) ABSTRACT

An image forming apparatus includes an image forming device to form an image on a sheet of recording media according to a toner adhering amount of each pixel and position data indicating a position of the pixel on the sheet, a storage device to store post-processing position data that indicates a position of post processing on the sheet, a retriever to retrieve the post-processing position data from the storage device, and a converter to convert the toner adhering amount of the pixel designated by the post-processing position data.

### CROSS-REFERENCE TO RELATED APPLICATION

This patent application is based on and claims priority pursuant to 35 U.S.C. §119 to Japanese Patent Application No. 2012-143026, filed on Jun. 26, 2012, in the Japan Patent Office, the entire disclosure of which is hereby incorporated by reference herein.

### BACKGROUND

1. Technical Field

The present invention generally relates to an image forming apparatus, such as, a copier, a printer, a facsimile machine, or a multifunction machine including at least two of these functions, that forms images on sheets of recording media subject to post processing such as stapling, punching, and the like; and also relates to an image data converter to convert image data used by an image forming apparatus and a method of converting image data therefor.

2. Description of the Background Art

Post processing or sheet processing, such as punching or stapling, is often performed on sheets of recording media on which images are formed by image forming apparatuses such as copiers, printers, or multifunction machines having these capabilities. For example, sheets are punched by punch units including a punch and a die to engage the punch. Alternatively, a bundle of sheets is stapled by staplers including a staple pusher to push staples into the sheets. The staple penetrates the bundle, and ends thereof are bent to bite into the bottom face of the bundle to fix the staple.

If areas in which images are formed are processed, for example, stapled or punched, it is possible that toner on the sheet is transferred to post-processing devices such as punch units, staplers, or the like. Specifically, toner on the sheet may adhere to a punch or a die of the punch unit. Similarly, toner may adhere to a staple pusher of the stapler when a bundle of sheets is stapled. Toner adhering to the post-processing device can cause malfunction of the post-processing device or adhere to subsequent sheets to be processed. Accordingly, it is possible that images formed by the image forming apparatus are disturbed.

### SUMMARY

One embodiment of the present invention provides an image forming apparatus to form an image on a sheet of recording media on which post processing is executed. The image forming apparatus includes an image forming device to form the image on the sheet according to a toner adhering amount of each pixel and position data indicating a position of the pixel on the sheet, a storage device to store post-processing position data that indicates a position of post processing on the sheet, a retriever to retrieve the post-processing position data from the storage device, and a converter to convert the toner adhering amount of the pixel designated by the post-processing position data.

Another embodiment provides an image data converter to convert image data according to which an image is formed on a sheet of recording media subject to post processing. The image data converter includes a storage device to store post-processing position data that indicates a position of post processing on the sheet, a retriever to retrieve the post-processing position data from the storage device, and a converter to convert lightness of each color of a pixel designated by the post-processing position data.

Yet another embodiment provides an image data converting method to convert image data according to which an image is formed on a sheet of recording media that is to be processed by a post-processing device. The method includes a step of retrieving post-processing position data that indicates a position of post processing on the sheet, and a step of converting lightness of each color of a pixel designated by the post-processing position data.

### BRIEF DESCRIPTION OF THE SEVERAL VIEWS OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram illustrating a configuration of an image forming system according to a first embodiment of the present invention;

FIG. 2 is a block diagram illustrating a hardware configuration of a controller of an image forming apparatus according to the first embodiment;

FIG. 3 is a functional block diagram of the controller of the image forming apparatus according to the first embodiment;

FIG. 4 is a table for post-processing management according to the first embodiment; FIG. 5 is a block diagram illustrating a hardware configuration of a controller of a sheet processing apparatus according to the first embodiment;

FIG. 6 is a functional block diagram of the controller of the sheet processing apparatus according to the first embodiment;

FIG. 7 is a flowchart illustrating a sequence of processes performed by the image forming apparatus according to the first embodiment;

FIGS. 8A, 8B, and 8C conceptually illustrate the image formation data according to the first embodiment;

FIG. 9 is a flowchart of conversion of the image formation data executed by a data converter according to the first embodiment;

FIG. 10 is a flowchart illustrating a sequence of processes executed by the sheet processing apparatus;

FIG. 11 is a block diagram illustrating a hardware configuration of a data processing device according to a second embodiment;

FIG. 12 is a block diagram illustrating a functional configuration of the data processing device according to the second embodiment; and

FIG. 13 is a flowchart illustrating a sequence of processes executed by the data processing device according to the second embodiment.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

Referring now to the drawings, wherein like reference numerals designate identical or corresponding parts throughout the several views thereof, image forming systems according to embodiments of the present invention are described.

It is to be noted that the suffixes Y, M, C, and K attached to each reference numeral indicate only that components indicated thereby are used for forming yellow, magenta, cyan, and black images, respectively, and hereinafter may be omitted when color discrimination is not necessary.

In the embodiments described below, an image forming apparatus form images according to a toner adhering amount of each pixel and position data indicating a position of the pixel on the sheet, and post processing is performed at positions on the sheet indicated by post-processing position data. In this configuration, the image forming system includes a storage device to store post-processing position data indicating the position where post processing is made on the sheet on which an image is formed, a retriever to retrieve the post-processing position data, and a converter to convert, image formation data such as toner adhering amount or lightness, of each pixel designated by the post-processing position data so that toner is not applied to such positions.

### First Embodiment

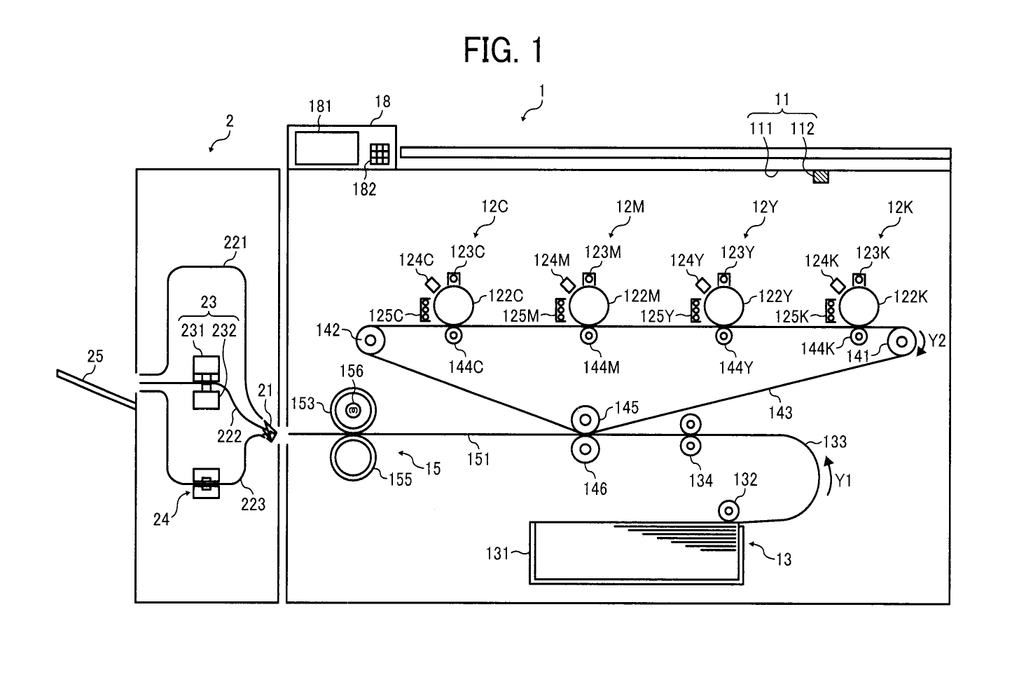

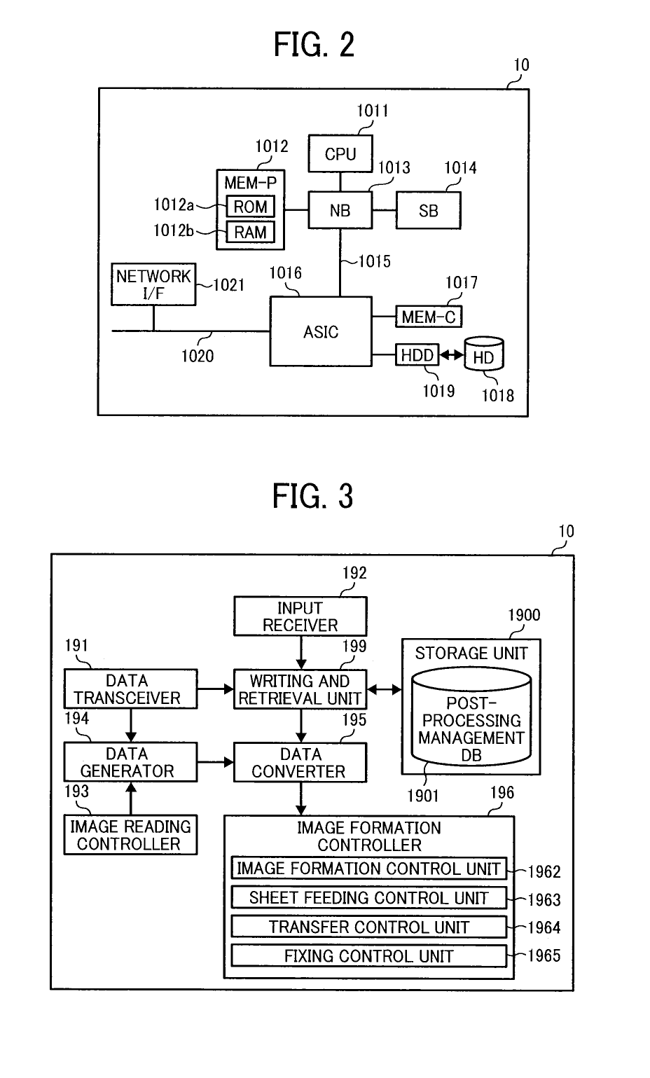

FIG. 1 is a schematic diagram illustrating a configuration of the image forming system according to the first embodiment. FIG. 2 is a block diagram illustrating a hardware configuration of a controller 10 of an image forming apparatus 1 according to the first embodiment.

As shown in FIG. 1, the image forming system according to the present embodiment includes the image forming apparatus 1 and a sheet processing apparatus 2. The image forming apparatus 1 and the sheet processing apparatus 2 can transmit data to and receive data from each other. A sheet inlet is formed in the sheet processing apparatus 2 and disposed adjacent to a discharge opening of the image forming apparatus 1 so that sheets of recording media discharged from the discharge opening can be inserted into the sheet inlet.

The image forming apparatus 1 is configured to form images on sheets of recording media such as plain paper, cardboard, overhead projector(OHP) film, or the like, and the sheet processing apparatus 2 performs post processing, such as punching, stapling, or the like, of the sheets on which images are formed.

A hardware configuration of the image forming apparatus 1 is described below.

In the configuration shown in FIG. 1, the image forming apparatus 1 includes an image reading device 11 configured to optically read image data of originals (i.e., document paper) placed on an exposure glass 111 and generate red, green, and blue (RGB) image data. Specifically, the image reading device 11 directs light onto the sheet and receives the light reflected from the sheet by a reading sensor 112 such as a charge-coupled device (CCD) or a contact image sensor (CIS), thereby acquiring the RGB image data. It is to be noted that RGB image data represents an image formed on a sheet of recording media and includes lightness of each of red, green, and blue.

In a center area of the image forming apparatus 1, an intermediate transfer belt 143 is looped around a driving roller 141, a driven roller 142, and a secondary-transfer roller 145. Four photoreceptor drums 122, namely, 122C, 122M, 122Y, and 122K, are disposed to contact the intermediate transfer belt 143. On the photoreceptor drums 122C, 122M, 122Y, and 122K respective color toner images are formed with cyan (C), magenta (M), yellow (Y), and black (K) toners. Across the intermediate transfer belt 143, primary-transfer rollers 144C, 144M, 144Y, and 144K are disposed facing the photoreceptor drums 122C, 122M, 122Y, and 122K, respectively. The toner images formed on the photoreceptor drums 122C, 122M, 122Y, and 122K are transferred onto an identical area of a surface of the intermediate transfer belt 143, thereby forming a multicolor toner image.

Additionally, a roller 146 is disposed at a position facing the secondary-transfer roller 145 (hereinafter “secondary-transfer facing roller 146”. The sheet and the intermediate transfer belt 143 carrying the multicolor toner image are pressed between the secondary-transfer roller 145 and the secondary-transfer facing roller 146.

A charging unit 123C is provided adjacent to the photoreceptor drum 122C and configured to charge the surface of the photoreceptor drum 122C uniformly. Additionally, an exposure unit 124C is provided adjacent to the photoreceptor drum 122C and configured to form an electrostatic latent image on the charged surface of the photoreceptor drum 122C. Specifically, the exposure unit 124 forms the electrostatic latent image based on the amount of toner applied or adhering to the photoreceptor drum 122C (i.e., toner adhering amount), and the toner adhering amount corresponds to a dot area ratio for each color determined by the controller 10. A developing device 125C disposed adjacent to the photoreceptor drum 122C develops with toner the electrostatic latent image on the photoreceptor drum 122C. The primary-transfer roller 144C applies a primary-transfer bias to the intermediate transfer belt 143 interposed between the primary-transfer roller 144C and the photoreceptor drum 122C. It is to be noted that the primary-transfer bias in the preset embodiment is electrical charges in the polarity opposite to that of electrical charge on the surface of the photoreceptor drum 122C.

The photoreceptor drum 122C, the charging unit 123C, the exposure unit 124C, and the developing device 125C together form an image forming unit 12C that serves as an embodiment of the image forming device. The image forming apparatus 1 further includes image forming units 12M, 12Y, and 12K each having a configuration similar to that of the image forming unit 12C except the color of toner used therein, and thus descriptions thereof are omitted.

The image forming apparatus 1 further includes a sheet feeder 13 to transport sheets to the position between the secondary-transfer roller 145 and the secondary-transfer facing roller 146. The sheet feeder 13 includes a sheet tray 131, a feed roller 132, a conveyance belt 133, and a pair of registration rollers 134. The sheet tray 131 contains sheets of recording media, and the feed roller 132 is rotatable to transport the sheet from the sheet tray 131 to the conveyance belt 133. The feed roller 132 sends out sheets from the sheet tray 131 one by one from the top to the conveyance belt 133.

The conveyance belt 133 transports the sheet forwarded by the feed roller 132. The registration rollers 134 are disposed upstream from the secondary-transfer roller 145 in the direction in which the conveyance belt 133 moves. The registration rollers 134 forward the sheet to the secondary-transfer roller 145, timed to coincide with the arrival of the toner image formed on the intermediate transfer belt 143.

A fixing device 15 is provided to fix the toner image transferred onto the sheet from the intermediate transfer belt 143. Specifically, with simultaneous application of heat and pressure thereto, a resin component of toner is fused and bonded to the sheet. The fixing device 15 includes a fixing roller 153 and a facing roller 155 facing the fixing roller 153. Additionally, a conveyance belt 151 is provided to transport the sheet to the fixing roller 153 after the toner is transferred thereto by the secondary-transfer roller 145. The conveyance belt 151 may be continuous with the conveyance belt 133 as shown in FIG. 1. The fixing roller 153 and the facing roller 155 clamp the sheet transported by the conveyance belt 151 therebetween. A heat generator 156 is provided inside the fixing roller 153. The heat generator 156 heats the sheet via the fixing roller 153.

On an outer face of the image forming apparatus 1, a control panel 18 is provided. The control panel 18 includes a panel display 181 and an input device 182. The panel display 181 displays setting values, selection screens, or both and accepts instructions from users. The panel display 181 can be, for example, a touch panel. The user can select the type and conditions of processing of sheets on which images are formed (i.e., post processing). The input device 182 includes numeric keys, a start key, and the like. For example, the user designates the number of copies using the numeric keys and instructs the apparatus to start image formation. It is to be noted that the term “post processing” used in this specification means sheet processing, such as punching or stapling, performed by the sheet processing apparatus 2.

The image forming apparatus 1 includes the controller 10 to control the above-described respective components. Referring to FIG. 2, the controller 10 includes a central processing unit (CPU) 1011, a main memory (MEM-P) 1012, a north bridge (NB) 1013, a south bridge (SB) 1014, an accelerated graphics port (AGP) bus 1015, an application specific integrated circuit (ASIC) 1016, a local memory (MEM-C) 1017, a hard disk (HD) 1018, a hard disk drive (HDD) 1019, a peripheral components interconnect (PCI) bus 1020, and a network interface (I/F) 1021.

The CPU 1011 executes data processing, computation, and control of the above-described components according to programs stored in the main memory 1012. The main memory 1012 serves as a memory storage area for the controller 10 and includes a read only memory (ROM) 1012a and random access memory (RAM) 1012b. The ROM 1012a stores programs and data to implement the functions of the controller 10. Alternatively, the program stored in the ROM 1012a can be recorded on computer-readable recording media such as a compact disc read only memory (CD-ROM), a floppy disk (FD), a compact disc-recordable (CD-R), a digital versatile disc (DVD) in the file form installable into or executable by the controller 10.

The RAM 1012b is used for expansion of programs and data and as a drawing memory. The NB 1013 serves as a bridge connecting the CPU 1011 to the main memory 1012, the SB 1014, and the AGP bus 1015. The SB 1014 serves as a bridge between the NB 1013 and peripheral devices. The AGP bus 1015 is a bus interface for graphics accelerator cards proposed to accelerate graphics processing. The ASIC 1016 includes a memory controller to control the local memory 1017 and multiple direct memory access controllers (DMACs) to execute rotation and the like of image data according to hardware logic. The ASIC 1016 is connected via the PCI bus 1020 to the network I/F 1021 such as a universal serial bus (USB) interface, an institute of electrical and electronics engineers (IEEE) 1394 interface.

The local memory 1017 is used as a buffer for images to be copied or codes. The RD 1018 stores image data, font data used in printing, and forms. The HDD 1019 controls data retrieval from and data writing in the HD 1018, controlled by the CPU 1011. The network I/F 1021 transmits data to and from external devices such as data processing devices via a communication network.

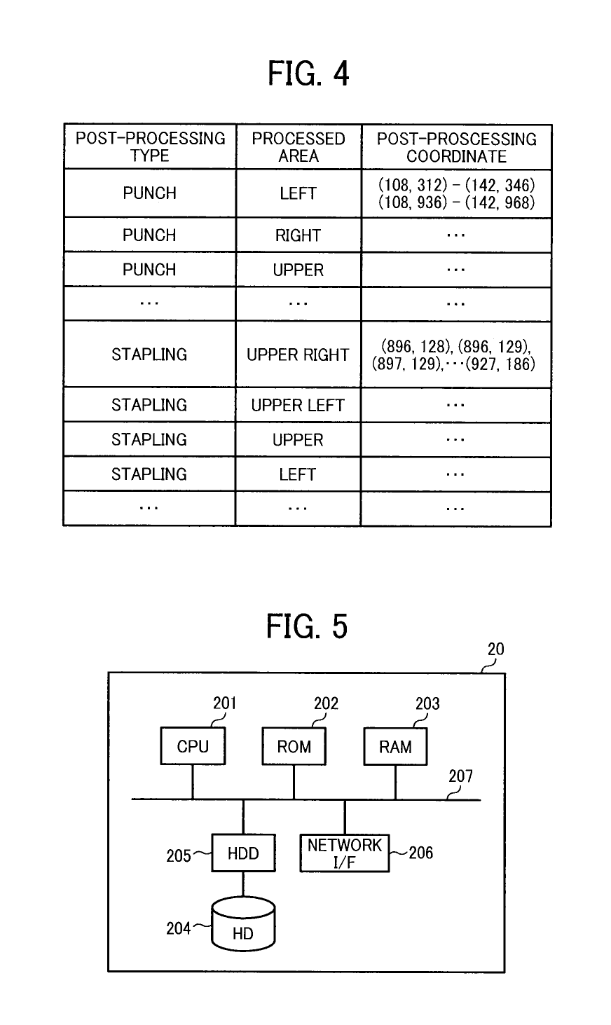

A functional configuration of the controller 10 of the image forming apparatus 1 is described below with reference to FIG. 3 and FIG. 4.

FIG. 3 is a functional block diagram of the controller 10 of the image forming apparatus 1 according to the first embodiment. FIG. 4 is a post-processing management table according to the first embodiment.

The controller 10 controls operation of the image forming apparatus 1 and, as shown in FIG. 3, includes a data transceiver 191, an input receiver 192, an image reading controller 193, a data generator 194, a data converter 195, an image formation controller 196, and a writing and retrieval unit 199. Each of these functional components is a function or means achieved by operations directed by the CPU 1011 according to the program stored in the ROM 1012a. Additionally, the controller 10 includes a storage unit 1900 built by the ROM 1012a or the HD 1018 shown in FIG. 2. The storage unit 1900 is an embodiment of the storage device.

In the storage unit 1900, a post-processing management database (DB) 1901 such as a post-processing management table shown in FIG. 4 is constructed. In the post-processing management table, post-processing data is associated or correlated with post-processing position data (also simply “processing position data” in drawings). The post-processing data indicates post-processing type and processed area data. The post-processing type in the present embodiment is either forming punch holes in the sheet (i.e., punching), binding multiple sheets together (stapling), or performing no sheet processing after image formation. The processed area data indicates the area on the sheet to be processed. Specifically, when the sheet is punched, the processed area data can indicate one of “left”, “right”, and “upper” as the position where punch holes are to be made. When the post-processing type is stapling, the processed area data can indicate one of “upper right”, “upper left”, “upper”, and “left” as the position to be stapled.

In FIG. 4, “post-processing coordinate” is an example of the post-processing position data and indicates the coordinate of the position to be stapled or where punch holes are made. The post-processing coordinate indicates a position corresponding to pixels forming the image formed by the image forming apparatus 1. In FIG. 4, coordinates (108, 312) to (142, 346) and (108, 936) to (142, 968) are associated with the post-processing type “punch” and the processed area data “left”. The writing and retrieval unit 199 is implemented by the HDD 1019 shown in FIG. 2. The writing and retrieval unit 199 stores and retrieves the post-processing data in and from the storage unit 1900. The writing and retrieval unit 199 is an embodiment of the retriever.

The data transceiver 191 is implemented by the network I/F 1021 shown in FIG. 2 and receives the RGB image data via the communication network from the data processing device or the like. The RGB image data represents an image formed on a sheet of recording media such as paper using lightness of each of red, green, and blue. The data transceiver 191 transmits the post-processing data to the sheet processing apparatus 2 via the communication network and receives data from the data processing device or the like. The data transceiver 191 is an embodiment of a data transceiver.

The input receiver 192 accepts various types of data input by the user via the control panel 18 shown in FIG. 1. The image reading controller 193 causes the image reading device 11 to optically read the image data of the original and generate the RGB image data.

The data generator 194 executes color space conversion and under color removal (UCR) of the RGB image data received by the data transceiver 191 or accepted by the image reading controller 193. With such image data processing, the data generator 194 converts the RGB image data into area ratios Rc, Rm, Ry, and Rk of dots formed with cyan (C), magenta (M), yellow (Y), and black (B) toners and generates image formation data that correlates the dot area ratio with the coordinate representing the position of each pixel.

It is to be noted that the data generator 194 may further execute adjustment of shading, positional deviation, and gamma in addition to color space conversion and under color removal. It is to be noted that the term “dot area ratio” means the ratio of the area in which dots are formed with each color toner in the area of a single pixel. Additionally, the dot area ratio can represent the amount of toner adhering to the photoreceptor drum 122 since the amount of toner transferred to the photoreceptor drum 122 by the image forming unit 12 corresponds to the dot area ratio.

The data converter 195 converts the image formation data generated by the data generator 194 according to the post-processing data. Specifically, the writing and retrieval unit 199 retrieves the post-processing coordinate based on the post-processing type and the processed area data included in the post-processing data received by the data transceiver 191. The data converter 195 converts the dot area ratio of each color of the pixel at the position designated by the post-processing coordinate to Rc=0, Rm=0, Ry=0, and Rk=0. The data converter 195 is an embodiment of the converter.

The image formation controller 196 includes an image formation control unit 1962 to control the image forming units 12, a sheet feeding control unit 1963 to control the sheet feeder 13, a transfer control unit 1964 to control the primary-transfer rollers 144, the secondary-transfer roller 145, and the intermediate transfer belt 143, and a fixing control unit 1965 to control the fixing device 15.

A hardware configuration of the sheet processing apparatus 2 is described below with reference to FIGS. 1 and 5.

The sheet processing apparatus 2 includes a controller 20. FIG. 5 is a block diagram illustrating a hardware configuration of the controller 20 of the sheet processing apparatus 2 according to the first embodiment.

In the present embodiment, the sheet processing apparatus 2 punches or staples the sheets on which images are formed by the image forming apparatus 1. As shown in FIG. 1, the sheet processing apparatus 2 includes a channel changer 21 disposed adjacent to the sheet inlet to receive sheets. The channel changer 21 switches its position to guide the sheet to one of multiple sheet conveyance channels, instructed by the controller 20. In the configuration shown in FIG. 1, one of first, second, and third conveyance channels 221, 222, and 223 formed in the sheet processing apparatus 2 is selected.

The second conveyance channel 222 includes the punch unit 23. The punch unit 23 is designed to punch sheets, controlled by the controller 20, and includes a punch 231 and a die 232. The punch 231 and the die 232 face each other. The sheets are punched when the punch 231 engages holes formed in the die 232 with the sheets interposed therebetween.

The third conveyance channel 223 is provided with the stapler 24 designed to staple the sheets, controlled by the controller 20. Neither the punch unit 23 nor the stapler 24 is provided in the first conveyance channel 223, and the first conveyance channel 223 extends to a sheet outlet. The conveyance channels 222 and 223 extend further from the punch unit 23 and the stapler 24, respectively, to the sheet outlet.

Referring to FIG. 5, the controller 20 includes a CPU 201 to control operation of the entire sheet processing apparatus 2, a ROM 202 to store data processing programs, a RAM 203 used as a work area of the CPU 201, an HD 204 to store various types of data, an HDD 205 to control data retrieval from and data writing in the HD 204, instructed by the CPU 201, a network I/F 206 to transmit data using the communication network, and a bus line 207 such as an address bus, a data bus, and the like to electrically connect the respective components. The ROM 202 stores sheet processing control programs (i.e., post-processing control programs).

A functional configuration of the sheet processing apparatus 2 is described below.

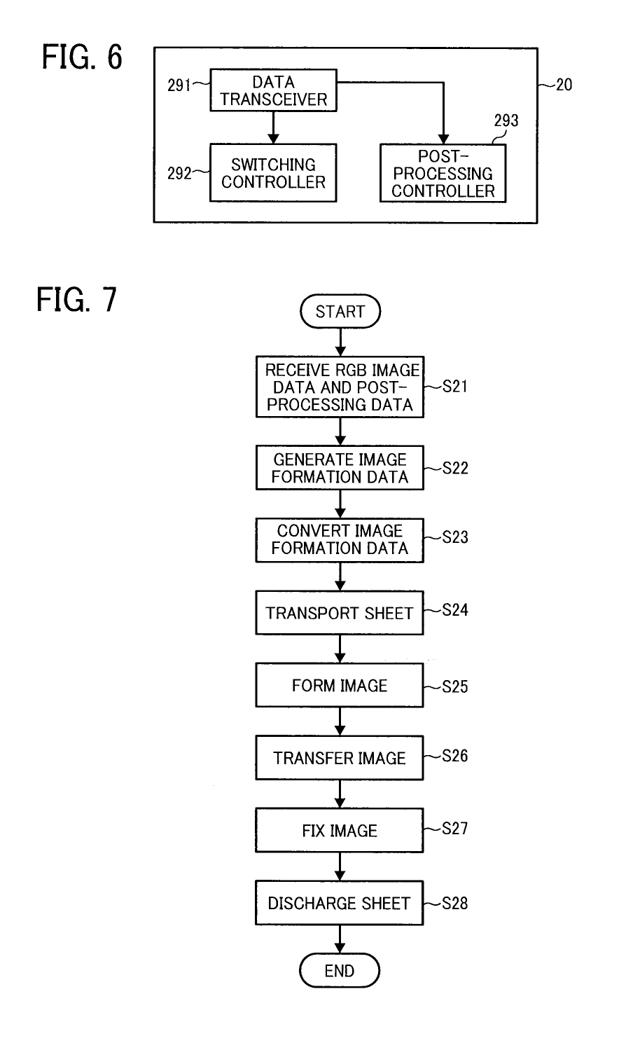

FIG. 6 is a block diagram illustrating a functional configuration of the controller 20 of the sheet processing apparatus 2 according to the first embodiment.

As shown in FIG. 6, the controller 20 includes a data transceiver 291, a switch controller 292, and a post-processing controller 293. Each of these functional components is a function or means achieved by operations directed by the CPU 201 according to the program stored in the ROM 202. The data transceiver 291 receives post-processing data from the image forming apparatus 1. The switch controller 292 causes the channel changer 21 to switch the conveyance channel in accordance with the post-processing type included in the post-processing data received by the data transceiver 291. The post-processing controller 293 controls the punch unit 23 and the stapler 24 in accordance with the processed area data included in the post-processing data.

Referring to FIGS. 7 through 10, processes of image formation and sheet processing according to the first embodiment are described.

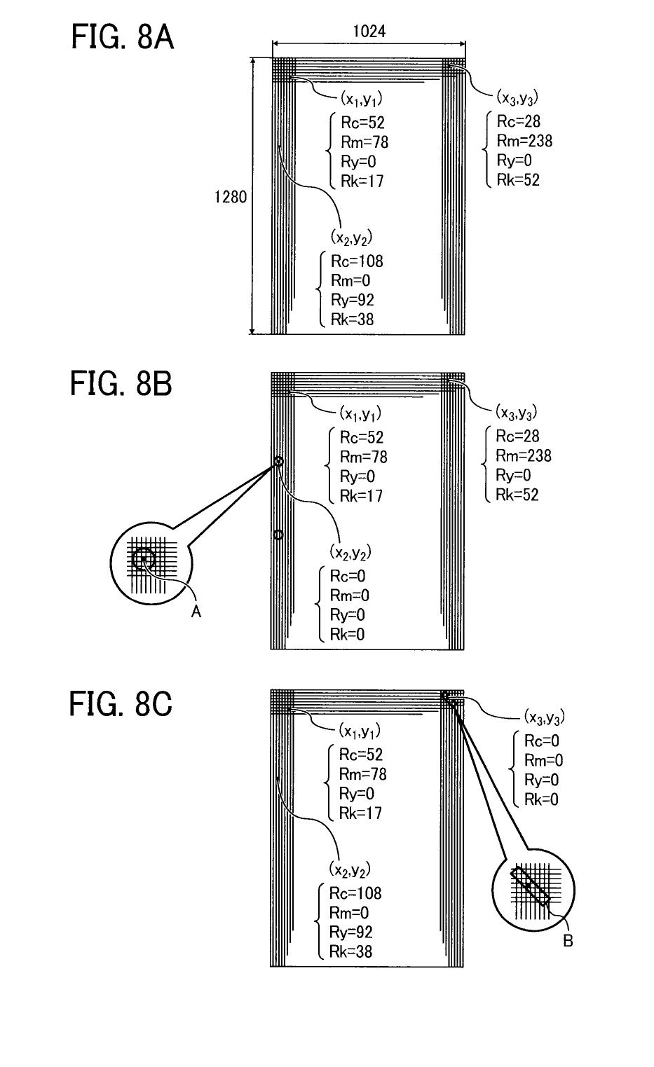

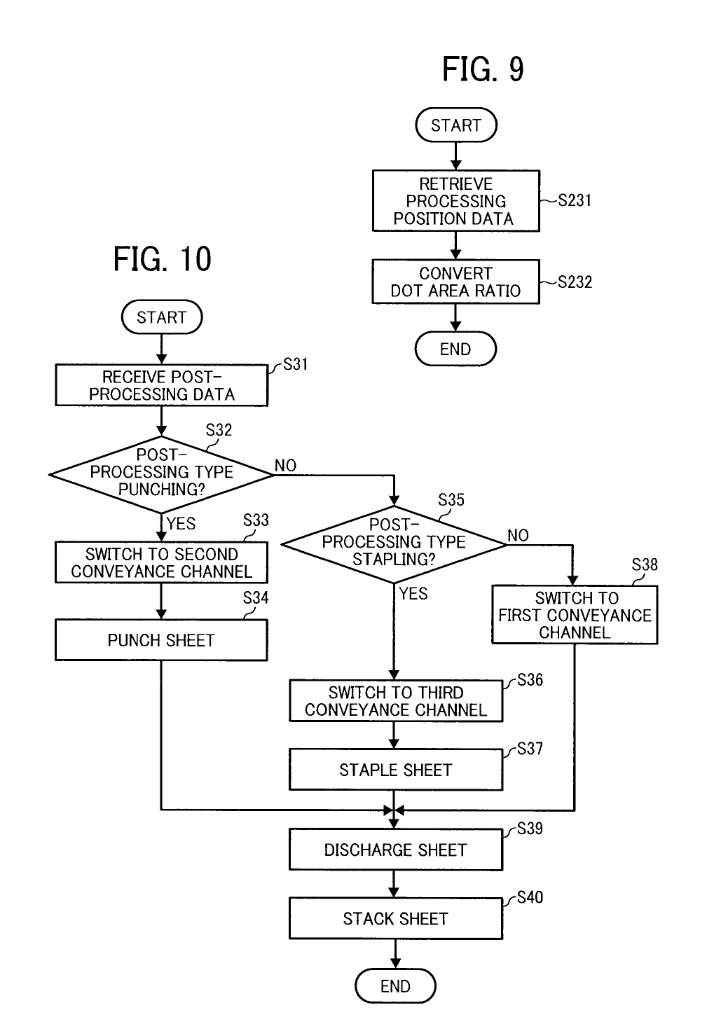

FIG. 7 is a flowchart illustrating a sequence of processes performed by the image forming apparatus 1 according to the first embodiment. FIGS. 8A, 8B, and 8C conceptually illustrate the image formation data according to the first embodiment. FIG. 9 is a flowchart of conversion of image formation data executed by the data converter 195 according to the first embodiment. FIG. 10 is a flowchart illustrating a sequence of processes executed by the sheet processing apparatus 2.

Referring to FIG. 7, at S21 the data transceiver 191 receives the RGB image data as well as the post-processing data from an external device such as a data processing device via the communication network. At S22, based on the RGB image data received by the data transceiver 191, the data generator 194 generates the image formation data, which is represented by the dot area ratios Rc, Rm, Ry, and Rk of cyan, magenta, yellow, and black toners.

Specifically, the data generator 194 converts color space of the RGB image data and removes under color from the RGB image data, thereby obtaining the dot area ratios Rc, Ry, and Rk, which represent the area ratios of dots formed with cyan, magenta, yellow, and black toners, respectively. It is to be noted that the data generator 194 may further execute known image processing of the RGB image data such as color correction, spatial frequency correction, or the like. Further, the data generator 194 computes the dot area ratio of every pixel on the sheet and generates the image formation data that includes the position of every pixel on the sheet and the dot area ratio corresponding to that position.

FIG. 8A is a conceptual diagram of the image formation data and illustrates the dot area ratios Re, Rm, Ry, and Rk of the respective colors at each pixel position. It is to be noted that FIG. 8A illustrates only the dot area ratios Re, Rm, Ry, and Rk at the coordinates (x₁, y₁), (x₂, y₂), and (x₃, y₃) although the image formation data includes the dot area ratios Rc, Rm, Ry, and Rk at every pixel position. In FIG. 8A, the pixel positioned at the coordinate (x₁, y₁) has the dot area ratios of Rc=52, Rm=78, Ry=0, and Rk=17. The dot area ratios of the pixel positioned at the coordinate (x₂, y₂) are Rc=108, Rm=0, Ry=92, and Rk=38. Additionally, the dot area ratios of the pixel positioned at the coordinate (x₃, y₃) are Rc=28, Rm=238, Ry=0, and Rk=52.

Subsequently to generation of the image formation data, at S23 the data converter 195 converts the image formation data according to the post-processing data received at S21. At S231 shown in FIG. 9, using the post-processing type and the processed area data included in the post-processing data received by the data transceiver 191 as search keys, the writing and retrieval unit 199 retrieves the post-processing position data (i.e., post-processing coordinate) associated therewith. At S232, the data converter 195 converts the dot area ratios Rc, Rm, Ry, and Rk of the pixel indicated by the retrieved post-processing position data into “zero (0)”.

For example, when the post-processing type is “punching” and the processed area data is “left”, the writing and retrieval unit 199 retrieves a group of post-processing coordinates (108, 312) to (142, 346) and (108, 936) to (142, 968) from the post-processing management table (shown in FIG. 4) in the post-processing management DB 1901 shown in FIG. 3.

FIG. 8B illustrates a position A on the sheet where a punch hole is formed corresponding to the image formation data shown in FIG. 8A. The position A is defined by the group of post-processing coordinates thus retrieved. The data converter 195 converts into zero the dot area ratios Rc, Rm, Ry, and Rk of the pixels disposed at the post-processing coordinates shown in FIG. 8B, among the image formation data shown in FIG. 8A. That is, the dot area ratios at the coordinate (x₂, y₂), which is one of the multiple post-processing coordinates, are converted into Rc=0, Rm=0, Ry=0, and Rk=0. It is to be noted that, at other coordinates than the post-processing coordinates retrieved by the writing and retrieval unit 199, the respective color dot area ratios Rc, Rm, Ry, and Rk are identical to those generated by the data generator 194.

Additionally, when the post-processing type is “stapling” and the processed area data is “upper right”, the writing and retrieval unit 199 retrieves a group of post-processing coordinates (896, 128), (896, 129), and (897, 129) to (927, 186) from the post-processing management table (shown in FIG. 4) in the post-processing management DB 1901 shown in FIG. 3.

FIG. 8C illustrates a position B on the sheet to be stapled corresponding to the image formation data shown in FIG. 8A. The position B is defined by the group of post-processing coordinates thus retrieved. The data converter 195 converts into zero the dot area ratios Rc, Rm, Ry, and Rk of the pixels disposed at the post-processing coordinates shown in FIG. 8C, among the image formation data shown in FIG. 8A. That is, the dot area ratios at the coordinate (x₃, y₃), which is one of the multiple post-processing coordinates, are converted into Rc=0, Rm=0, Ry=0, and Rk=0. It is to be noted that, at other coordinates than the post-processing coordinates retrieved by the writing and retrieval unit 199, the respective color dot area ratios Rc, Rm, Ry, and Rk are identical to those generated by the data generator 194.

As described above, the image formation data generated by the data generator 194 are converted by the data converter 195.

Referring back to FIG. 7, at S24, the sheet feeder 13 transports sheets (sheet feeding), instructed by the sheet feeding control unit 1963. Specifically, the feed roller 132 sends out sheets one by one from the sheet tray 131 to the conveyance belt 133. The conveyance belt 133 moves in the direction indicated by arrow Y1 shown in FIG. 1, thereby transporting the sheet to the registration rollers 134. Then, the registration rollers 134 sandwich the sheet therebetween and retains the sheet until the toner image formed on the intermediate transfer belt 143 arrives at the secondary-transfer roller 145. The registration rollers 134 forward the sheet to the position between the secondary-transfer roller 145 and the secondary-transfer facing roller 146, timed to coincide with the arrival of the toner image at the secondary-transfer roller 145.

At S25, controlled by the image formation control unit 1962, the image forming units 12 forms the toner images on the respective photoreceptor drums 122 according to the image formation data converted by the data converter 195. Specifically, initially the charging unit 123C uniformly charges the surface of the rotating photoreceptor drum 122C. The exposure unit 124C directs a laser beam onto the charged surface of the photoreceptor drum 122C according to the dot area ratio Rc of the image formation data. Thus, an electrostatic latent image, constructed of electrostatic electrical charges according to the dot area ratio, is formed on the photoreceptor drum 122C.

Subsequently, the developing device 125C develops the electrostatic latent image with cyan toner. Thus, a cyan toner image is formed on the photoreceptor drum 122C. Magenta, yellow, and black toner images are formed on the photoreceptor drums 122M, 122Y, and 122K, respectively, through processes similar to those for cyan, and thus the descriptions thereof are omitted.

At S26, transfer of the toner images from the respective photoreceptor drums 122 is performed controlled by the transfer control unit 1964.

Specifically, the primary-transfer rollers 144 apply the primary-transfer bias to the intermediate transfer belt 143. Then, the toner images are transferred from the respective photoreceptor drums 122 onto the intermediate transfer belt 143 (primary image transfer).

The intermediate transfer belt 143 onto which the toner images are transferred moves in the direction indicated by arrow Y2 shown in FIG. 1 as the driving roller 141 and the driven roller 142 rotate. Timed to coincide with the arrival of the toner image at the secondary-transfer roller 145, the registration rollers 134 send out the retained sheet thereto. Subsequently, the secondary-transfer roller 145, which is rotated by the driving roller 141 and the driven roller 142, applies the secondary-transfer bias to the sheet and the intermediate transfer belt 143 interposed between the secondary-transfer roller 145 and the secondary-transfer facing roller 146. Then, the toner image is transferred from the intermediate transfer belt 143 onto the sheet (secondary image transfer). It is to be noted that the secondary-transfer bias in the preset embodiment is electrical charges in the polarity opposite to that of electrical charge on the surface of the intermediate transfer belt 143.

At S27 the fixing device 15 fixes the toner image on the sheet, controlled by the fixing control unit 1965. Specifically, the conveyance belt 151 transports the sheet onto which the toner image is transferred to the fixing roller 153. When the sheet reaches the position where the fixing roller 153 contacts the fixing belt 152, the fixing roller 153 presses the sheet against the facing roller 155. Since the fixing roller 153 is heated by the heat generator 156, the sheet is heated at a predetermined fixing temperature while being pressed. Then, the toner on the sheet is fused. As the fixing roller 153 and the facing roller 155 press the fused toner, the resin component in toner is fixed on the sheet. Subsequently, at S28 the sheet is discharged from the image forming apparatus 1 through the discharge opening.

Next, sheet processing in the sheet processing apparatus 2 is described with reference to FIG. 10.

As shown in FIG. 10, when the sheet is inserted into the sheet processing apparatus 2, the data transceiver 291 of the sheet processing apparatus 2 receives the post-processing data from the image forming apparatus 1 at S31. At S32, the switch controller 292 judges whether or not the post-processing type, indicated by the post-processing data received by the data transceiver 291, is “punching”.

When the post-processing type is “punching” (Yes at S32), at S33 the switch controller 292 switches the position of the channel changer 21 to transport the sheet through the second conveyance channel 222. When the sheet transported through the second conveyance channel 222 reaches the punch unit 23, at S34 the punch unit 23 punches a hole in the processed area indicated by the post-processing data received by the data transceiver 291.

When the post-processing type is not “punching” (No at S32), at S35 the switch controller 292 further judges whether or not the post-processing type is “stapling”. When the post-processing type is “stapling”, (Yes at S35), at S36 the switch controller 292 switches the position of the channel changer 21 to transport the sheet through the third conveyance channel 223. When the sheet transported through the third conveyance channel 223 reaches the stapler 24, at S37 the stapler 24 staples the processed area indicated by the post-processing data received by the data transceiver 291. When the post-processing type is not “stapling”, (No at S35), at S36 the switch controller 292 switches the position of the channel changer 21 to transport the sheet through the first conveyance channel 223. Thus, the sheet is transported through the first conveyance channel 223.

At S39 the sheet punched, stapled, or transported through the first conveyance channel 223 is discharged through the sheet outlet and stacked on the discharge tray 25 at S40.

Thus, according to the first embodiment, the image forming apparatus 1 converts into “0” the dot area ratio at the position subject to post processing (sheet processing) by the sheet processing apparatus 2. Accordingly, toner does not adhere to the punch unit 23 or the stapler 24 when the sheet processing apparatus 2 performs post processing such as punching or stapling. Therefore, malfunction of the punch unit 23 and the stapler 24 can be inhibited. Additionally, adhesion of toner to sheets in subsequent sheet processing can be prevented, thus inhibiting occurrence of image failure.

The first embodiment also provides a method of converting image data according to which an image is formed on a sheet of recording media subject to post processing. The method includes a step of storing post-processing position data that indicates the position to be processed by the sheet processing device, a step of retrieving the post-processing position, and a step of converting toner adhering amount of each color of a pixel designated by the post-processing position data such as post-processing coordinates. This method can be made into programs executable by the image forming apparatus 1, data processing devices, or computers and recorded in non-transitory recording media readable by the image forming apparatus 1, data processing devices, or computers.

### Second Embodiment

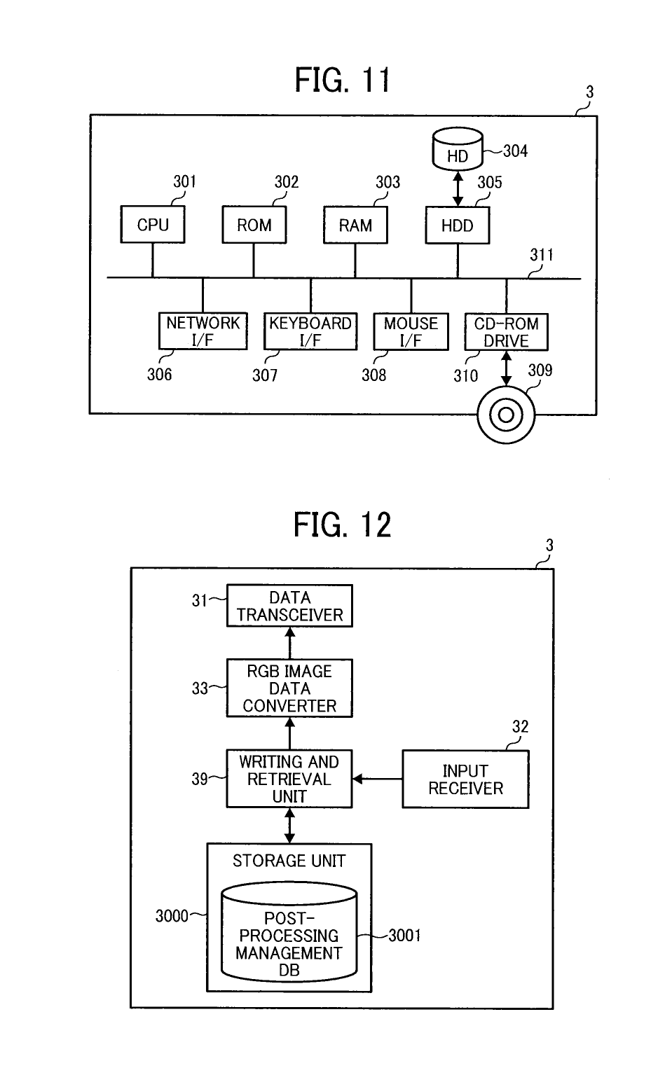

Although the controller 10 of the image forming apparatus 1 includes the data converter 195 in the above-described first embodiment, alternatively, an RGB image data converter 33 may be included in a data processing device 3, such as a computer, that transmits data via a communication network to the image forming apparatus 1 as in a second embodiment described below. The image forming apparatus 1, the sheet processing apparatus 2, and the data processing device 3 according to the second embodiment are described below with reference to FIGS. 11 through 13.

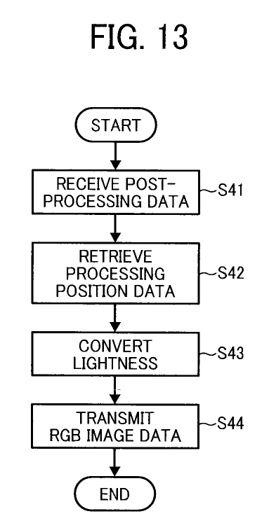

FIG. 11 is a block diagram illustrating a hardware configuration of the data processing device 3 according to the second embodiment. FIG. 12 is a block diagram illustrating a functional configuration of the data processing device 3 according to the second embodiment. FIG. 13 is a flowchart illustrating a sequence of processes executed by the data processing device 3.

A hardware configuration of the data processing device 3 is described below.

Referring to FIG. 11, the data processing device 3 includes a CPU 301 to control operation of the entire data processing device 3, a ROM 302 to store programs for data processing devices, a RAM 303 used as a work area of the CPU 301, an HD 304 to store various types of data, an HDD 305 to control data retrieval from and data writing in the HD 304, instructed by the CPU 301, a network I/F 306 to transmit data using the communication network, a keyboard I/F 307 provided with multiple keys to input letters, numbers, various types of instructions, a mouse I/F 308 to select one of the instructions, execute the instruction, designate a processed object, move a cursor, and the like, a CD-ROM drive 310 to control data retrieval from and data writing in a CD-ROM 309 serving as a removably insertable recording medium, and a bus line 311 such as an address bus, a data bus, and the like to electrically connect the respective components.

Next, a functional configuration of the data processing device 3 is described below with reference to FIG. 12.

The data processing device 3 includes a data transceiver 31, an input receiver 32, an RGB image data converter 33, and a writing and retrieval unit 39, which are directed by the CPU 301 according to the programs for data processing devices. The data transceiver 31 receives data from and transmits data to the image forming apparatus 1 via the communication network or the like. The input receiver 32 can be implemented by the keyboard I/F 307, the mouse I/F 308, or both and configured to accept information input by the user via a keyboard or a mouse. The RGB image data converter 33 can convert the RGB image data generated or received by the data processing device 3. The writing and retrieval unit 39 and the storage unit 3000 are similar to the writing and retrieval unit 199 and the storage unit 1900 according to the first embodiment, respectively, and thus descriptions thereof are omitted. It is to be noted that the data processing device 3 is an embodiment of an image data converter.

Additionally, the image forming apparatus 1 and the sheet processing apparatus 2 in the second embodiment are similar to those in the first embodiment except that the data converter 195 is not included in the image forming apparatus 1. Thus, their descriptions are omitted.

Operations of the respective apparatuses and the data processing device 3 in the second embodiment are described below with reference to FIG. 13.

As shown in FIG. 13, at S41 the input receiver 32 accepts the post-processing data including the post-processing type and the processed area data input into the data processing device 3 by the user using the keyboard or the mouse. At S42, using the post-processing type and the processed area data included in the post-processing data received by the input receiver 32 as search keys, the writing and retrieval unit 39 retrieves the post-processing position data (i.e., post-processing coordinate) associated therewith.

In the second embodiment, the RGB image data represents an image using the lightness of red, green, and blue, and the RGB image data converter 33 converts the color of the pixels in the processed area into white. Specifically, at S43 the RGB image data converter 33 converts the lightness of the respective colors of the pixel positioned at the post-processing coordinate retrieved at S42 into 255 (R=255, G=255, and B=255). The data transceiver 31 transmits the converted RGB image data to the image forming apparatus 1 via the communication network or the like.

According to the RGB image data received from the data processing device 3, the image forming apparatus 1 performs the steps at S21, S22, and S24 through S28 shown in FIG. 7. When the lightness of each color is 255 (R=255, G=255, and B=255), the color becomes white. Accordingly, in the image formation data generated at S22 by the data generator 194, the dot area ratios of pixels having such lightness are designated to Rc=0, Rm=0, and Ry=0.

Therefore, when an image is formed according to the image formation data, toner is not applied to the processed area.

Thus, the second embodiment also provides a method of converting image data according to which an image is formed on a sheet of recording media subject to post processing. The method includes a step of retrieving post-processing position data that indicates a position of post processing on the sheet on which the image is formed, and a step of converting lightness of each color of a pixel designated by the post-processing position data such as post-processing coordinates. This method can be made into programs executable by the data processing device 3 and recorded in non-transitory recording media readable by the data processing device 3 or computers.

Thus, according to the second embodiment, the data processing device 3 converts each color lightness at the position on the sheet where post processing is made so that the position is kept white. Accordingly, toner does not adhere to the punch unit 23 or the stapler 24 when the sheet processing apparatus 2 performs post processing such as punching or stapling. Therefore, malfunction of the punch unit 23 and the stapler 24 can be inhibited. Additionally, adhesion of toner to sheets in subsequent sheet processing can be prevented, thus inhibiting occurrence of image failure.

Although the above-described embodiments concern image formation using cyan, magenta, yellow, and black toners, alternatively, transparent toner (i.e., clear toner) may be used in addition to the four color toners. Transparent toner can be constructed of resin particles. When superimposed on colored toner, the transparent toner can keep the colored toner visible.

Additionally, although the post-processing coordinate is retrieved from the post-processing management table in the post-processing management DB 1901 using the post-processing type and the processed area data as the search keys, the post-processing coordinate may be retrieved otherwise. For example, when the sheet processing apparatus 2 includes the punch unit 23 but does not include other post-processing devices (such as the stapler 24), the search key may be only the processed area data. Yet alternatively, for example, when the sheet processing apparatus 2 does not include other post-processing devices than the punch unit 23 and the punched position is fixed, the storage unit 1900 stores fixed values as the post-processing coordinate. In such a case, the search key is not necessary to retrieve the post-processing coordinate.

Further, although the data generator 194 generates the image formation data according to the RGB image data received by the data transceiver 191, the RGB image data based on which the data generator 194 generates the image formation data may be read by the image reading device 11 and accepted by the image reading controller 193. In such case, the data generator 194 can convert the image formation data based on the post-processing data input by the user using the control panel 18 and accepted by the input receiver 192.

Additionally, although the image formation data is generated based on the RGB image data in the second embodiment, the image formation data can be generated based on monochrome or single color image data when images are formed using a single color toner (e.g., black toner). In this specification, image data means either RGB or monochrome image data.

It is to be noted that the order of steps in the above-described methods is not limited thereto.

Numerous additional modifications and variations are possible in light of the above teachings. It is therefore to be understood that, within the scope of the appended claims, the disclosure of this patent specification may be practiced otherwise than as specifically described herein.

What is claimed is:

1. An image forming apparatus comprising:
an image forming device to form an image on a sheet of recording media according to a toner adhering amount of each pixel and position data indicating a position of the pixel on the sheet;
a storage device to store post-processing position data that indicates a position of post processing on the sheet;
a retriever to retrieve the post-processing position data from the storage device; and
a converter to convert the toner adhering amount of the pixel designated by the post-processing position data.

2. The image forming apparatus according to claim 1, further comprising:
a data receiver to receive a type of post processing executed on the sheet on which the image is formed,
wherein the storage device stores the post-processing position data in association with the type of post processing, and
the retriever uses the type of post processing received by the data receiver as a search key to retrieve the post-processing position data from the storage device.

3. The image forming apparatus according to claim 2, wherein the data receiver further receives processed area data that indicates an area of the sheet in which post processing is performed,
the storage device stores the post-processing position data in association with the processed area data in addition to the type of post processing, and
the retriever uses, in addition to the type of post processing, the processed area data received by the data receiver as a search key to retrieve the post-processing position data from the storage device.

4. The image forming apparatus according to claim 1, wherein the converter converts into zero the toner adhering amount of each color of the pixel designated by the post-processing position data.

5. The image forming apparatus according to claim 1, wherein the post processing comprising punching and stapling of the sheet.

6. An image data converter to convert image data according to which an image is formed on a sheet of recording media subject to post processing, the image data converter comprising:
a storage device to store post-processing position data that indicates a position of post processing on the sheet;
a retriever to retrieve the post-processing position data from the storage device; and
a converter to convert lightness of each color of a pixel designated by the post-processing position data.

7. The image data converter according to claim 6, further comprising:
a data receiver to receive a type of post processing executed on the sheet,
wherein the storage device stores the post-processing position data in association with the type of post processing, and
the retriever uses the type of post processing received by the data receiver as a search key to retrieve the post-processing position data from the storage device.

8. The image data converter according to claim 7, wherein the data receiver further receives processed area data that indicates an area of the sheet in which post processing is performed,
the storage device stores the post-processing position data in association with the processed area data in addition to the type of post processing, and
the retriever uses, in addition to the type of post processing, the processed area data received by the data receiver as a search key to retrieve the post-processing position data from the storage device.

9. The image data converter according to claim 6, wherein the converter converts into 255 the lightness of each color of the pixel designated by the post-processing position data.

10. A method of converting image data according to which an image is formed on a sheet of recording media subject to post processing, the method comprising:
retrieving post-processing position data that indicates a position of post processing on the sheet on which the image is formed; and
converting lightness of each color of a pixel designated by the post-processing position data.
